(19) United States
(12) Patent Application Publication
(10) Pub. No.: US 2014/0326666 A1
(43) Pub. Date: Nov. 6, 2014

(54) APPARATUS AND METHODS FOR REMOVING CONTAMINANTS FROM WASTEWATER

(71) Applicant: HYSSOP BRANCH, LLC, Granbury, TX (US)

(72) Inventors: Bob R. Drew, Granbury, TX (US); David Potter, Granbury, TX (US)

(73) Assignee: HYSSOP BRANCH, LLC, Granbury, TX (US)

(21) Appl. No.: 13/887,077

(22) Filed: May 3, 2013

(51) Int. Cl. C02F 1/44; B01D 61/12; B01D 61/02

(52) U.S. Cl. CPC C02F 1/441; B01D 61/022; B01D 61/12; C02F 1/56
USPC 210/637; 210/257.2; 210/96.2; 210/202

(57) ABSTRACT

Apparatus and methods are provided for removing solids from wastewater. The apparatus may include a dissolved solids removal system including a first membrane stack for removing a first portion of dissolved solids from wastewater, the first membrane stack having a first rejection rate and including at least one first membrane having a first operating pressure rating. A first solution unit may be included downstream of the at least one first membrane, the first solution unit being configured to maintain a differential pressure over the at least one first membrane below the first operating pressure rating. The dissolved solids removal system may also include a final membrane stack for removing a final portion of dissolved solids from the wastewater, the final membrane stack being located downstream of the first membrane stack and having a final rejection rate higher than the first rejection rate.

### TECHNICAL FIELD

The present invention relates generally to the field of water processing, and more particularly to apparatuses and methods for removing contaminants from wastewater.

### BACKGROUND

Wastewater produced by hydraulic fracturing (“fraccing”) or other methods is traditionally collected and disposed of or processed to remove contaminants. For example, contaminant removal processes may involve filtration of the wastewater and traditional reverse osmosis processes. However, because of filter and membrane capacities and structural limitations, these processes are limited in the concentration of wastewater total dissolved solids (“TDS”) able to be processed. For example, traditional processes are designed to handle wastewater in the range of 30,000-40,000 ppm TDS. Accordingly, it would be desirable to provided apparatuses and methods for removing contaminants from wastewater having increased TDS concentration.

### SUMMARY

In one aspect, an apparatus for removing solids from wastewater is provided, which includes a wastewater input for providing wastewater having a first concentration of total dissolved solids and a dissolved solids removal system. The dissolved solids removal system includes a first membrane stack for removing a first portion of dissolved solids from the wastewater. The first membrane stack has a first rejection rate and includes at least one first membrane having a first operating pressure rating. A first solution unit is provided downstream of the at least one first membrane and is configured to maintain a differential pressure over the at least one first membrane below the first operating pressure rating. The dissolved solids removal system also includes a final membrane stack for removing a final portion of dissolved solids from the wastewater. The final membrane stack is located downstream of the first membrane stack and has a final rejection rate higher than the first rejection rate.

In another aspect, a method for removing solids from wastewater is provided, which includes passing wastewater having a first concentration of total dissolved solids through at least one first membrane having a first rejection rate and a first operating pressure rating, maintaining a concentration of total dissolved solids in a first output solution from the at least one first membrane, such that a differential pressure over the at least one first membrane is below the first operating pressure rating, and passing the wastewater through at least one final membrane having a final rejection rate higher than the first rejection rate.

### BRIEF DESCRIPTION OF THE DRAWINGS

FIG. 1 is a plan diagram of an embodiment of a dissolved solids removal system.

FIG. 2 is a plan diagram of an embodiment of a membrane stack of a dissolved solids removal system.

FIG. 3 is a plan diagram of an embodiment of a suspended solids removal system.

FIG. 4 is a graph showing percent recovery per wastewater TDS concentration for one embodiment of an apparatus for removing solids from wastewater.

### DETAILED DESCRIPTION

The present application will now be described more fully hereinafter with reference to the accompanying drawings, in which several embodiments of the application are shown. Like numbers refer to like elements throughout the drawings.

In the following description, numerous specific details are given to provide a thorough understanding of embodiments. The embodiments can be practiced without one or more specific details, or with other methods, components, materials, and the like. In other instances, well known structures, materials, or operations are not shown or described in detail to avoid obscuring aspects of the embodiments.

Reference throughout the specification to “one embodiment,” “an embodiment,” or “certain embodiments” means that a particular feature, structure, or characteristic described in connection with the embodiment is included in at least one embodiment. Thus, the appearances of the phases “in one embodiment” or “in an embodiment” in various places throughout the specification are not necessarily referring to the same embodiment. Furthermore, the particular features, structures, or characteristics may be combined in any suitable manner in one or more embodiments.

The apparatus and methods described herein provide for the removal of contaminants from wastewater. Contaminants may include both undissolved, i.e., suspended, and dissolved solids. For example, wastewater produced by fraccing may contain undissolved proppant, such as sand or other particulates, as well as sodium chlorides, barium chlorides, manganese, sodium phosphate, calcium, magnesium, and other compounds. The concentration of TDS in frac water may be up to 100,000 ppm or higher. For example, some frac water contains TDS in concentrations of about 200,000 ppm.

The apparatus and methods described herein may remove both suspended and dissolved solids from the wastewater to produce potable water and heavy brine. As used herein, the term “potable” refers to clean fresh water having a TDS concentration up to 1,000 ppm. For example, potable water may have a TDS concentration of from about 100 ppm to about 800 ppm. As used herein, the term “heavy brine” refers to saltwater solutions having a TDS concentration of above 200,000 ppm. For example, heavy brine may have a TDS of from about 250,000 ppm to about 300,000 ppm. Additional products may be collected from the apparatus and methods described herein. For example, crude and methane gas may be separated and collected from the apparatus and methods. Saturated waste for disposal may also be collected.

Apparatus

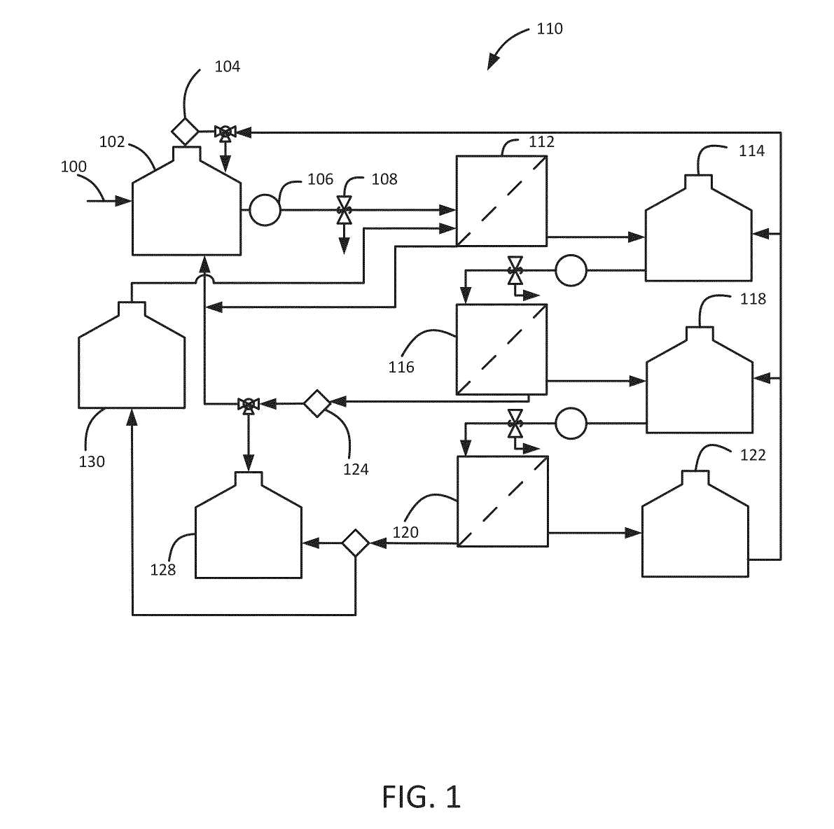

As shown in FIG. 1, an apparatus for removing solids from wastewater includes a wastewater input 100 and a dissolved solids removal system 110. The wastewater input may provide wastewater having a first concentration of total dissolved solids. For example, the wastewater provided to the dissolved solids removal system 110 may be frac water obtained from a well or may be wastewater that has undergone preliminary processing, such as a suspended solids removal process prior to being introduced to the dissolved solids removal system 110. In certain embodiments, the first concentration of TDS is above 100,000 ppm. For example, the first concentration of TDS may be from about 100,000 ppm to about 200,000 ppm.

In certain embodiments, the wastewater is introduced to a first solution tank 102, in which the concentration of TDS in the wastewater is measured by a sensor 104 and diluted with water having a lower TDS concentration if the concentration of TDS in the wastewater exceeds a predetermined threshold. For example, the wastewater in the first solution tank 102 may be diluted by potable water from the final solution unit 122. Once the wastewater in the first solution tank 102 has a TDS concentration below the predetermined threshold, it may be introduced to a series of membrane stacks for removing the dissolved solids from the wastewater. For example, the predetermined threshold may be from about 150,000 ppm to about 250,000 ppm. In one embodiment, the predetermined threshold is about 200,000 ppm. Thus, a first input solution entering the first membrane stack 112 has a second concentration of TDS that may be equal to or less than the first concentration of TDS in the wastewater provided to the dissolved solids removal system.

The dissolved solids removal system 110 includes a first membrane stack 112 for removing a first portion of dissolved solids from the wastewater. In certain embodiments, the wastewater is directed from the first solution tank 102 to the first membrane stack 112 by a high pressure pump 106. A relief valve 108 may be provided to protect the membrane stack downstream from pressures exceeding its design limits.

The first membrane stack 112 has a first rejection rate and includes at least one first membrane having a first operating pressure rating. As used herein, the term “rejection rate” refers to the percentage of the amount of TDS eliminated from a solution by the membrane it passes through. In certain embodiments, the first rejection rate is from about 70% to about 80%. For example, the first rejection rate may be about 73%. The first membrane stack 112 may be configured to generally reject the larger molecules present in the wastewater, for example divalents and trivalents such as calcium, magnesium, and phosphates, while allowing a significant portion of sodium chloride and almost all the fluid volume to pass through the first membrane stack 112. For example, the output from a first membrane stack having a first rejection rate of 73% will contain 27% salts. The first membrane stack may have a recovery rate from about 80% to about 99%. In one embodiment, the first membrane stack has a recovery rate of about 90%. As used herein, the term “recovery rate” refers to the percentage of the feed stream, or input water, that is recovered as permeate, or “cleaner” output water, from the membrane.

The first membrane stack 112 includes one or more membranes. In one embodiment, the first membrane stack includes a series of four individual pressure housings, each pressure housing containing at least one membrane. For example, each pressure housing may contain three membranes. Each membrane has an operating pressure rating indicating the maximum pressure capacity of the membrane. For example, the at least one first membrane may have a first operating pressure rating of above 1,000 psi. In one embodiment, the first operating pressure rating is from about 1,000 psi to about 1,700 psi. For example, the first operating pressure rating may be about 1,200 psi. The at least one first membrane may have an oversized brine channel. For example, the at least one first membrane may have a pore size such that at least 50% of sodium chloride dissolved in the wastewater is able to pass through the at least one first membrane. In one embodiment, the at least one first membrane is configured to allow up to 75% of the sodium chloride pass therethrough. In another embodiment, the at least one first membrane is configured to allow up to 90% of the sodium chloride to pass therethrough.

In certain embodiments, the at least one first membrane has a flux rate from about 35 GFD to about 45 GFD (gallons per square foot per day) as measured at 150 psi with 2,000 ppm sodium chloride. In one embodiment, the at least one first membrane has a permeability flux rate of about 37.5 GFD (gallons per square foot per day) as measured at 150 psi with 2,000 ppm sodium chloride. For example, the at least one first membrane may be the HB750 membrane manufactured by SEPRO Membranes of Oceanside, Calif.

The dissolved solids removal system 110 also includes a first solution unit 114 downstream of the at least one first membrane. The first solution unit 114 is configured to maintain a differential pressure over the at least one first membrane below the first operating pressure rating. For example, the first solution unit may be a tank, an inline mixing unit, or another structure operable to maintain the differential pressure over the first membrane. In certain embodiments, the first solution unit 114 includes a tank that collects the output of the first membrane stack 112. The first solution unit may be connected to a source of water having a lower TDS concentration than the solution contained in the first solution unit, such that the solution may be diluted to a desired TDS concentration before being provided to additional membrane stacks downstream.

In certain embodiments, the first solution unit is configured to maintain the differential pressure over the at least one first membrane by monitoring the concentration of TDS in the first output solution contained in the first solution unit and diluting the first output solution to a third concentration of TDS lower than the first concentration of TDS, such that the differential pressure between the first input solution and the first output solution over the membrane is less than the first operating pressure rating. For example, the third concentration of TDS may be lower than the first concentration of TDS and lower than or equal to the second concentration of TDS. In certain embodiments, the third concentration of TDS is lower than the second concentration of TDS.

Generally, as the TDS concentration of a solution increases, the pressure required to overcome the osmotic pressure, i.e., the pressure that must be applied to the solution to prevent inward flow of water across the membrane, also increases. The osmotic pressure of a solution may be approximated as TDS divided by 100. Accordingly, the maximum TDS concentration of a solution entering a membrane is 100 times the maximum operating pressure rating of that membrane. For example, if a membrane ruptures at 1000 psi (i.e., has an operating pressure rating of 1000 psi), the maximum TDS concentration that may be filtered by that membrane is 100,000 ppm.

The first solution unit therefore maintains a TDS concentration downstream of the at least one first membrane such that the differential osmotic pressure across the membranes does not exceed the operating pressure rating of the membrane. As compared to traditional cascade-structure systems in which the downstream TDS concentration is near 0 ppm and thus the maximum TDS that may be processed is 100 times the operating pressure rating of the membrane, the first solution unit significantly increases the maximum TDS concentration that may be processed by the membrane. For example, in a traditional cascade system having a membrane with an operating pressure rating of 1,000 psi, the maximum TDS concentration of the input solution is 100,000 ppm. In contrast, the apparatus and methods described herein allow processing of input solutions having increased TDS concentrations by controlling the downstream TDS concentration of the output solution, such that the differential pressure between the input and output solutions is lower than the maximum pressure capacity of the membrane. Thus, the apparatus and methods of the present disclosure are capable of processing wastewater having significantly higher TDS concentrations than can be processed in typical systems.

In certain embodiments, the apparatus includes TDS concentration monitors and controllers which automatically blend the solution in the first solution unit 114 to maintain the desired differential pressures.

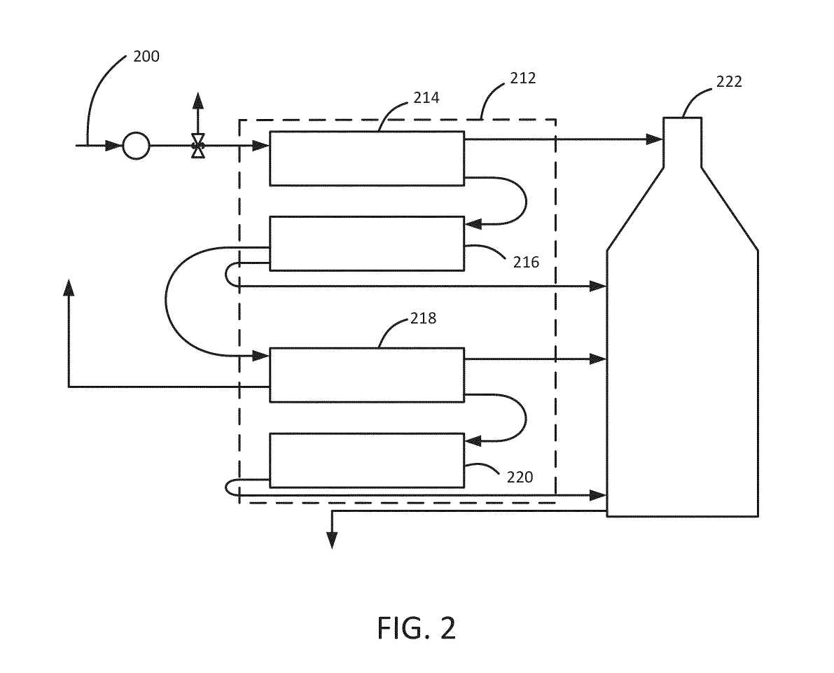

In embodiments in which the first membrane stack includes multiple membranes, each membrane within the stack may be connected to a solution unit downstream thereof. For example, the differential pressure over each individual membrane of a membrane stack may be monitored and controlled as described above. In certain embodiments, one or more individual membranes are contained within a pressure housing. As shown in FIG. 2, the first membrane stack 212 has four pressure housings 214, 216, 218, 220 configured in series. Each pressure housing contains at least one membrane. Each pressure housing 214, 216, 218, 220 is connected to first solution unit 222 such that the downstream TDS concentration from each membrane and/or each pressure housing may be controlled and the differential pressure over each membrane is kept below the operating pressure rating of that membrane.

The membrane stack 212 may be configured such that the concentrated waste solution output from each pressure housing flows into the next pressure housing in series (e.g., the waste output from pressure housing 214 flows into pressure housing 216), while the solution output from each pressure housing flows into the first solution unit 222. As shown in FIG. 1, The concentrated waste solution output from the first membrane stack 112 is directed to the first solution tank 102.

In certain embodiments, the dissolved solids removal system 110 includes a second membrane stack 116 for removing a second portion of dissolved solids from the wastewater. The second membrane stack 116 may be located downstream of the first membrane stack 112 and have a second rejection rate higher than the first rejection rate. For example, the second rejection rate may be from above 75% to about 95%. In one embodiment, the second rejection rate is about 95%. For example, the at least one second membrane stack may be configured to remove a majority of the sodium chloride and barium chloride present in the wastewater. In certain embodiments, the at least one second membrane stack is configured to remove at least 75% of the sodium chloride present in the wastewater.

The second membrane stack 116 may include at least one second membrane having a second operating pressure rating. In certain embodiments, the second membrane stack includes at least one pressure housing containing at least one of the second membranes. For example, the second pressure rating may be from about 600 psi to about 1,100 psi. In one embodiment, the second pressure rating is about 1,000 psi. For example, each second membrane contained in the second membrane stack may be the same.

A second solution unit 118 may be provided downstream of the at least one second membrane and configured to maintain a differential pressure over the at least one second membrane below the second operating pressure rating. In certain embodiments, a second input solution has a fourth concentration of total dissolved solids and enters the at least one second membrane. The second solution unit may be configured to maintain the differential pressure over the at least one second membrane by monitoring and diluting the second output solution to a fifth concentration of TDS lower than the third concentration of TDS, such that the differential pressure between the second input solution and the second output solution over the at least one second membrane is less than the second operating pressure rating. For example, the fifth concentration of TDS may be lower than the third concentration of TDS and lower than or equal to the fourth concentration of TDS. In certain embodiments, the fifth concentration of TDS is lower than the fourth concentration of TDS.

In certain embodiments, each membrane and/or pressure housing of the second membrane stack is connected to a solution unit downstream thereof. For example, the differential pressure over each individual membrane of the second membrane stack may be monitored and controlled as described above. The second membrane stack 116 may be configured such that the concentrated waste solution output from each membrane and/or pressure housing flows into the next membrane and/or pressure housing in series, while the solution output from each membrane and/or pressure housing flows into the second solution unit 118.

As shown in FIG. 1, the concentrated waste solution output from the second membrane stack 116 is directed to a conductivity sensor 124, which measures the TDS concentration of the waste solution and directs it to either the brine tank 128 or the first solution tank 102. For example, if the TDS concentration is equal to or greater than 200,000 ppm, the solution may be directed to the brine tank, while if the TDS concentration is less than 200,000 ppm, it is directed to the first solution tank.

The dissolved solids removal system 110 also includes a final membrane stack 120 for removing a final portion of dissolved solids from the wastewater. The final membrane stack 120 is located downstream of the first membrane stack 112 and has a final rejection rate higher than the first rejection rate. In certain embodiments, the final rejection rate is from above about 95% to about 99.9%. For example, the final rejection rate may be about 99.5%. The final membrane stack may have a final rejection rate such that a final output solution is potable water. The final output solution from the final membrane stack is collected in final solution unit 122. In certain embodiments, the final membrane stack 120 is also downstream of the second membrane stack 116, and the final rejection rate is also higher than the second rejection rate.

The final membrane stack 120 may include at least one final membrane, which may be contained within one or more pressure housings. For example, each final membrane contained in the final membrane stack may be the same. The final membrane stack 120 may be configured such that the concentrated waste solution output from each membrane and/or pressure housing flows into the next membrane and/or pressure housing in series, while the solution output from each membrane and/or pressure housing flows into the final solution unit 122. As shown in FIG. 1, the concentrated waste solution output from the final membrane stack 120 is directed to brine tank 128.

In certain embodiments, the pH of the wastewater provided to the membrane stacks is adjusted to be slightly acidic to prevent erosion of the filters. For example, the pH of the wastewater may be maintained at a pH from about 4 to about 6.5. In one embodiment, ferric chloride is injected into the wastewater to achieve the acidic pH.

In certain embodiments, the apparatus is fully automated, requiring no hands-on personnel other than those needed to initiate operations, perform routine maintenance as indicated by the monitoring computer system, and manage the traffic flow of water trucks depositing the wastewater and collecting the fresh water.

The apparatus may also be self-monitoring. For example, as the wastewater is being processed, the operating pressures and flow rates throughout the apparatus may be monitored. If a predetermined threshold pressure is reached, for example due to scaling of the membranes, the system may automatically switch from “production mode” to “cleaning mode.” Cleaning mode may include flushing the membrane stacks with a cleaning solution contained in flush tank 130. Once flushing is completed, the system will return to production mode.

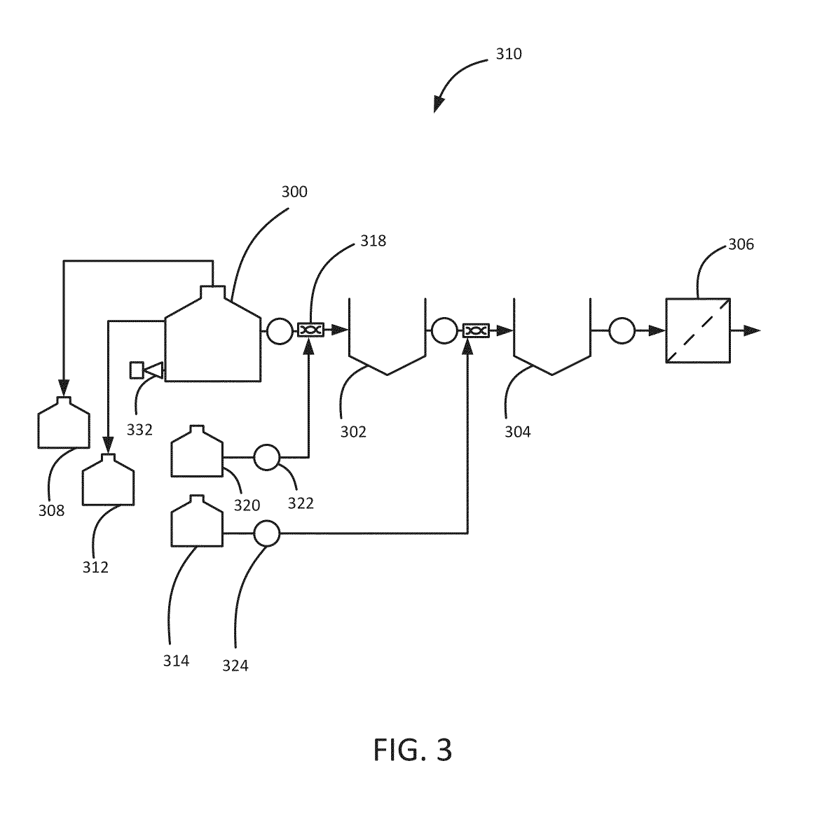

As shown in FIG. 3, the apparatus may also include a suspended solids removal system 310. The suspended solids removal system 310 may be upstream of the dissolved solids removal system and configured to remove a majority of the undissolved solids from the wastewater.

In one embodiment, the suspended solids removal system 310 includes a raw water tank 300 for storing the raw wastewater to be processed. For example, the raw wastewater may be frac water. Raw water tank 300 may include a skimmer operable to skim the crude oil from the surface of the raw wastewater contained in raw water tank 300. The crude oil may be collected and stored in crude oil tank 312. The raw water tank may also include absorption pads configured to absorb oil from the tank 300. Aeration pump 332 may be provided to inject bursts of air into the raw water tank 300 to cause the water to roll or boil. This action causes the wastewater to release trapped gases, such as methane, which may be removed by a vapor collection apparatus. Methane may be collected and stored in methane tank 308.

In one embodiment, the suspended solids removal system 310 includes at least one clarifier 302, 304, to which the wastewater is provided. The clarifier may extract suspended solids by allowing the solids to settle and subsequently be removed. Injection pumps may be provided to inject chemicals into the wastewater. The injected chemicals may be selected to alter the size and/or weight of the suspended solids to aid in the clarification process. For example, first chemical tank 320 may contain a flocculant, such as a polymer flocculant, that is pumped by first injection pump 322 into the wastewater upstream of the first clarifier 302. An inline mixer 318 may mix the flocculant into the wastewater. For example, second chemical tank 314 may contain an acid, such as ferric chloride, that is pumped by second injection pump 324 into the wastewater upstream of the second clarifier.

In one embodiment, the suspended solids removal system 310 includes at least one microfilter 306. For example, the microfilter may be configured to trap and absorb any remaining suspended particles in the wastewater. The microfilter may also include one or more bag filters.

Methods

Methods for removing solids from wastewater are also provided herein. The methods may include any combination of the apparatus features described above. In certain embodiments, the method includes (i) passing wastewater having a first concentration of TDS through at least one first membrane having a first rejection rate and a first operating pressure rating, (ii) maintaining a concentration of TDS in a first output solution from the at least one first membrane, such that a differential pressure over the at least one first membrane is below the first operating pressure rating, and (iii) passing the wastewater through at least one final membrane having a final rejection rate higher than the first rejection rate. In one embodiment, the at least one final membrane produces a final output solution that is potable water.

In certain embodiments, the method also includes, between steps (ii) and (iii), passing the wastewater through at least one second membrane having a second rejection rate higher than the first rejection rate and lower than the final rejection rate, and a second operating pressure rating, and maintaining the concentration of TDS in the second output solution from the at least one second membrane, such that a differential pressure over the at least one second membrane is below the second operating pressure rating.

In one embodiment, the first input solution entering the at least one first membrane has a second concentration of TDS and the second input solution entering the at least one second membrane has a fourth concentration of TDS. The step of maintaining the concentration of TDS in the first output solution may include monitoring and diluting the first output solution to a third concentration of TDS lower than the first concentration of TDS, such that the differential pressure between the first input solution and the first output solution over the at least one first membrane is less than the first operating pressure rating. Likewise, the step of maintaining the concentration of TDS in the second output solution comprises monitoring and diluting the second output solution to a fifth concentration of TDS lower than the third concentration of TDS, such that the differential pressure between the second input solution and the second output solution over the at least one second membrane is less than the second operating pressure rating.

For example, the third concentration of TDS may be lower than the first concentration of TDS and lower than or equal to the second concentration of TDS, while the fifth concentration of TDS may be lower than the third concentration of TDS and lower than or equal to the fourth concentration of TDS. In certain embodiments, the third concentration of TDS is lower than the second concentration of TDS and the fifth concentration of TDS is lower than the fourth concentration of TDS.

In certain embodiments, the methods include removing the suspended solids from the wastewater prior to removing the dissolved solids therefrom. For example, the method may include passing the wastewater through at least one clarifier and at least one microfilter to remove suspended solids prior to passing it through the at least one first membrane.

### Experimental Results

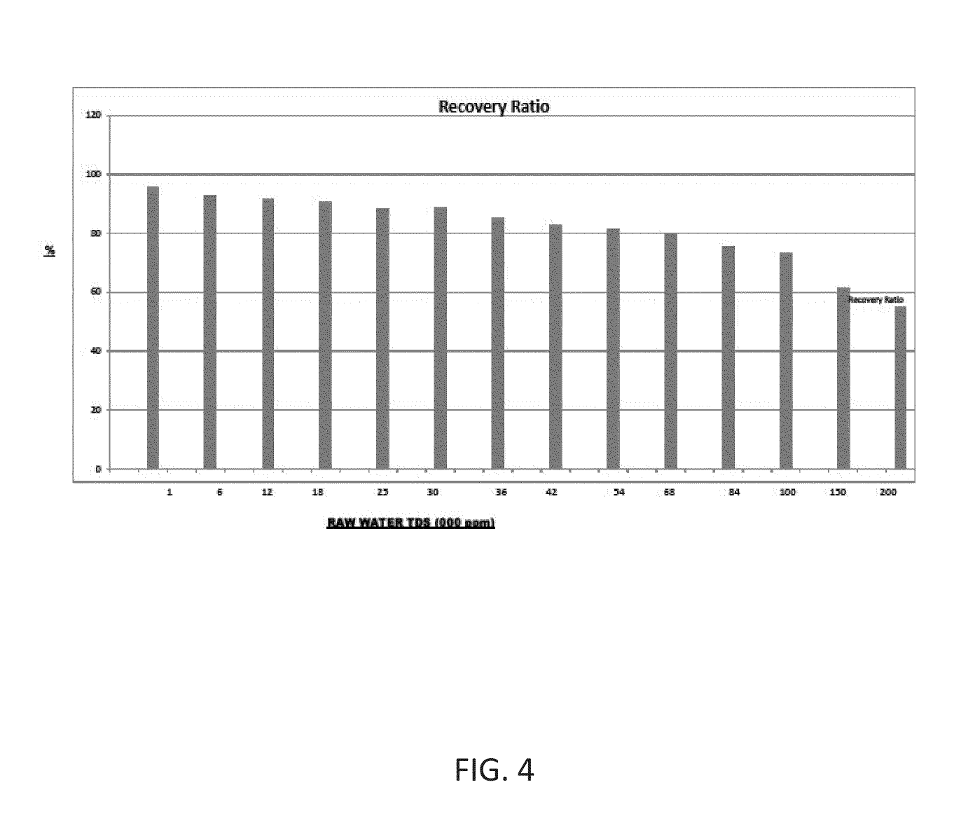

FIG. 4 shows the results of processing wastewater having various TDS concentrations in an apparatus as described herein. The experimental apparatus includes a suspended solids removal system and a dissolved solids removal system. The dissolved solids removal system includes three membrane stacks, each stack having four individual membranes. The first membrane stack has a first rejection rate of about 73%, the second membrane stack has a rejection rate of about 95%, and the final membrane stack has a rejection rate of about 99.5%. The first membrane stack includes four membranes having operating pressure ratings of 1,500 psi.

As shown in FIG. 4, raw water samples having TDS concentrations ranging from 1,000 ppm to 200,000 ppm were processed by the experimental apparatus and the percent recovery of potable water was measured. The recovery rates ranged from above 90% for raw water with a TDS concentration of 1,000 ppm, to 80% for raw water with a TDS concentration of 68,000 ppm, and above 50% recovery for raw water with a TDS concentration of 200,000 ppm. These results demonstrate a significant increase in recovery rate as compared to traditional water contamination removal systems. For example, traditional desalination reverse osmosis systems have recovery rates around 50% for water having a TDS concentration of 30,000 ppm. Additionally, these results demonstrate the ability of the apparatus and methods described herein to process raw water having TDS concentrations well above the limits of traditional systems (i.e., around 100,000 ppm).

Publications cited herein and the materials for which they are cited are specifically incorporated by reference herein. Modifications and variations of the methods and compositions described herein will be obvious to those skilled in the art from the foregoing detailed description. Such modifications and variations are intended to come within the scope of the appended claims.

I claim:

1. An apparatus for removing solids from wastewater, comprising:
a wastewater input for providing wastewater having a first concentration of total dissolved solids; and
a dissolved solids removal system, which comprises:
a first membrane stack for removing a first portion of dissolved solids from the wastewater, the first membrane stack having a first rejection rate and comprising at least one first membrane having a first operating pressure rating;
a first solution unit downstream of the at least one first membrane, the first solution unit being configured to maintain a differential pressure over the at least one first membrane below the first operating pressure rating; and
a final membrane stack for removing a final portion of dissolved solids from the wastewater, the final membrane stack being located downstream of the first membrane stack and having a final rejection rate higher than the first rejection rate.

2. The apparatus of claim 1, further comprising:
a second membrane stack for removing a second portion of dissolved solids from the wastewater, the second membrane stack being located downstream of the first membrane stack and upstream of the final membrane stack, having a second rejection rate higher than the first rejection rate and lower than the final rejection rate, and comprising at least one second membrane having a second operating pressure rating; and
a second solution unit downstream of the at least one second membrane, the second solution unit being configured to maintain a differential pressure over the at least one second membrane below the second operating pressure rating.

3. The apparatus of claim 2, wherein:
a first input solution has a second concentration of total dissolved solids and enters the at least one first membrane,
a second input solution has a fourth concentration of total dissolved solids and enters the at least one second membrane,
the first solution unit is configured to maintain the differential pressure over the at least one first membrane by monitoring a concentration of total dissolved solids in a first output solution contained in the first solution unit and diluting the first output solution to a third concentration of total dissolved solids lower than the first concentration of total dissolved solids, such that the differential pressure between the first input solution and the first output solution over the at least one first membrane is less than the first operating pressure rating, and
the second solution unit is configured to maintain the differential pressure over the at least one second membrane by monitoring a concentration of total dissolved solids in a second output solution contained in the second solution unit and diluting the second output solution to a fifth concentration of total dissolved solids lower than the third concentration of total dissolved solids, such that the differential pressure between the second input solution and the second output solution over the at least one second membrane is less than the second operating pressure rating.

4. The apparatus of claim 1, wherein the final membrane stack has a final rejection rate such that a final output solution is potable water.

5. The apparatus of claim 1, wherein the first operating pressure rating is from about 1,000 psi to about 1,500 psi.

6. The apparatus of claim 1, wherein the first operating pressure rating is above 1,000 psi.

7. The apparatus of claim 1, wherein the first concentration of total dissolved solids is from about 100,000 ppm to about 200,000 ppm.

8. The apparatus of claim 1, wherein the first concentration of total dissolved solids is above 100,000 ppm.

9. The apparatus of claim 2, wherein the first rejection rate is from about 70% to about 80%, the second rejection rate is from above about 80% to about 95%, and the final rejection rate is from above about 95% to about 99.9%.

10. The apparatus of claim 2, wherein the first rejection rate is about 73%, the second rejection rate is about 95%, and the final rejection rate is about 99.5%.

11. The apparatus of claim 1, wherein the at least one first membrane has a pore size such that at least 50% of NaCl dissolved in the wastewater is able to pass through the at least one first membrane.

12. The apparatus of claim 1, further comprising:
a suspended solids removal system upstream of the dissolved solids removal system, the suspended solids removal system comprising:
at least one clarifier; and
at least one microfilter.

13. The apparatus of claim 12, wherein the at least one clarifier comprises a flocculant injector.

14. The apparatus of claim 12, wherein the at least one clarifier comprises an acid injector.

15. A method for removing solids from wastewater, comprising:
passing wastewater having a first concentration of total dissolved solids through at least one first membrane having a first rejection rate and a first operating pressure rating;
maintaining a concentration of total dissolved solids in a first output solution from the at least one first membrane, such that a differential pressure over the at least one first membrane is below the first operating pressure rating; and
passing the wastewater through at least one final membrane having a final rejection rate higher than the first rejection rate.

16. The method of claim 15, further comprising:
after passing the wastewater through the at least one first membrane and before passing the wastewater through the at least one final membrane, passing the wastewater through at least one second membrane having a second rejection rate higher than the first rejection rate and lower than the final rejection rate, and a second operating pressure rating; and
maintaining a concentration of total dissolved solids in a second output solution from the at least one second membrane, such that a differential pressure over the at least one second membrane is below the second operating pressure rating.

17. The method of claim 16, wherein:
a first input solution has a second concentration of total dissolved solids and enters the at least one first membrane,
a second input solution has a fourth concentration of total dissolved solids and enters the at least one second membrane,
the maintaining the concentration of total dissolved solids in the first output solution comprises monitoring the first output solution and diluting the first output solution to a third concentration of total dissolved solids lower than the first concentration of total dissolved solids, such that the differential pressure between the first input solution and the first output solution over the at least one first membrane is less than the first operating pressure rating, and
the maintaining the concentration of total dissolved solids in the second output solution comprises monitoring the second output solution and diluting the second output solution to a fifth concentration of total dissolved solids lower than the third concentration of total dissolved solids, such that the differential pressure between the second input solution and the second output solution over the at least one second membrane is less than the second operating pressure rating.

18. The method of claim 15, wherein the at least one final membrane produces a final output solution is potable water.

19. The method of claim 15, wherein the first operating pressure rating is from about 1,000 psi to about 1,500 psi.

20. The method of claim 15, wherein the first operating pressure rating is above 1,000 psi.

21. The method of claim 15, wherein the first concentration of total dissolved solids is from about 100,000 ppm to about 200,000 ppm.

22. The method of claim 15, wherein the first concentration of total dissolved solids is above 100,000 ppm.

23. The method of claim 16, wherein the first rejection rate is from about 70% to about 80%, the second rejection rate is from above about 80% to about 95%, and the third rejection rate is from above about 95% to about 99.9%.

24. The method of claim 16, wherein the first rejection rate is about 73%, the second rejection rate is about 95%, and the third rejection rate is about 99.5%.

25. The method of claim 15, wherein the at least one first membrane has a pore size such that at least 50% of NaCl in the wastewater is able to pass through the at least one first membrane.

26. The method of claim 15, further comprising passing the wastewater through at least one clarifier and at least one microfilter to remove suspended solids prior to passing it through the at least one first membrane.

27. The method of claim 25, wherein the at least one clarifier comprises a flocculant injector.

28. The method of claim 25, wherein the at least one clarifier comprises an acid injector.

29. The apparatus of claim 1, wherein the first membrane stack comprises one or more first pressure housings, each first pressure housing containing at least one first membrane.

30. The apparatus of claim 2, wherein the second membrane stack comprises one or more second pressure housings, each second pressure housing containing at least one second membrane.
